(19) United States
(12) Patent Application Publication
(10) Pub. No.: US 2016/0260043 A1
(43) Pub. Date: Sep. 8, 2016

(54) SYSTEM AND METHOD FOR DETERMING EMPLOYEE PERFORMANCE AND PROVIDING EMPLOYEE LEARNING

(71) Applicants: Watsco Inc., Coconut Grove, FL (US); Pandera Systems, Orlando, FL (US)

(72) Inventors: Aaron Nahmad, Coconut Grove, FL (US); Joshua Sutton, Orlando, FL (US); Steven Rupp, Coconut Grove, FL (US)

(73) Assignees: Pandera Systems, Orlando, FL (US); Watsco Inc., Coconut Grove, FL (US)

(21) Appl. No.: 14/638,626

(22) Filed: Mar. 4, 2015

(51) Int. Cl. G06Q 10/06

(52) U.S. Cl. CPC G06Q 10/06398

(57) ABSTRACT

An aspect of the present disclosure involves systems, software, and computer-implemented methods for determining employee performance and providing employee learning. The system may include an input module that is utilized to input assessment data related to performance metrics for an employee, utilizing the assessment data from a plurality of evaluators. The system may further include a scoring component that creates a score of the currently assessed employee through a normalized method. The system may also include a display component that allows viewing of an employee's evaluation.

### BACKGROUND OF THE INVENTION

The typical business environment includes a number of employees who contribute their skills and knowledge to further the business. It is a goal of management to achieve a maximum productivity and efficiency by having each employee utilize their skills and knowledge to their fullest potential.

Traditional incentives and training programs have a number of shortcomings which provide challenges to management seeking to obtain maximum productivity and efficiency. Without personalization, transparence, and continuous feedback, employees can lose their motivational power. Typical strategies for management to increase productivity include periodic assessments, certification and learning programs, as well as public rewards of the most productive employees.

During the periodic assessments, the contributions of each employee are typically analyzed to determine potential rewards as bonuses and promotions. However, specific feedback is typically not communicated back to the employee for future development, and the assessments themselves are done sporadically. Certification and learning programs can become rote exercises and feel like extra work to the employees, and as a consequence the employees may lack engagement or become zoned out of the process. This can lead to management spending time and resources on expensive programs without changing employee behavior or making a difference in customer service.

Furthermore, the top employees may hold onto their knowledge rather than sharing it, thereby failing to utilize the company's full human potential. Additionally, the metrics used to rank employees often favor those experienced employees who learn how to game the system, and thus newer employees feel as though they are at a disadvantage. A newer employee feeling as though they are at a disadvantage may not buy in to the system, and as a consequence will likely not be as productive as possible.

Accordingly, it would be beneficial to provide a system which provides specific feedback regarding employee performance, and also tracks employee performance over time. To increase motivation, the system should create a level playing field for all employees and also be engaging and fun. The system should not only reward the top performers, but also spur behaviors in all employees and thus enable lower performing employees to learn from the leaders.

### SUMMARY OF THE INVENTION

Aspects of the present disclosure address at least the above-mentioned problems and/or disadvantages and provide at least the advantages described below. Accordingly, an aspect of the present disclosure involves systems, software, and computer-implemented methods for determining employee performance and providing employee learning.

The system may include an input module that is utilized to input assessment data related to performance metrics for an employee, utilizing the assessment data from a plurality of evaluators. The system may further include a scoring component that creates a score of the currently assessed employee through a normalized method. The system may also include a display component that allows viewing of an employee's evaluation.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram of an exemplary personal computer system that can be used to implement embodiments of the invention;

FIG. 2 is a “League Scoreboard” screenshot according to an embodiment of the present invention.

FIG. 3 is a “Head to Head” screen according to an embodiment of the present invention.

FIG. 4 is a “My Score” screen according to an embodiment of the present invention.

FIG. 5 is a “Team Roster” screen according to an embodiment of the present invention.

FIG. 6 is a “My Notes” screen according to an embodiment of the present invention.

FIG. 7 is a “Playbook Profile” screen according to an embodiment of the present invention.

FIG. 8 is an “Activity Board” screen according to an embodiment of the present invention.

### DETAILED DESCRIPTION OF THE INVENTION

The following description is provided to assist in a comprehensive understanding of exemplary embodiments of the invention as defined by the claims and their equivalents. It includes various specific details to assist in that understanding; however these specific details are to be regarded as merely exemplary. Accordingly, those of ordinary skill in the art will recognize that various changes and modifications of the embodiments described herein can be made without departing from the scope and spirit of the invention.

The present disclosure involves systems, software, and computer-implemented methods for determining employee performance and providing employee learning. A gamification engine is connected to a backend database which provides employee data. The gamification engine can gather the gamification data describing the users through a user interface (UI) clients infrastructure implemented in a business software environment. In some implementations, a user can access the business software environment, particularly, a computer system in the environment, using a client device such as an tablet device or a smart phone. When the user does so, the business software environment can present a user interface in the client device. Gamification logic can be executed in the user interface through which the gamification data can be collected and provided to the gamification engine.

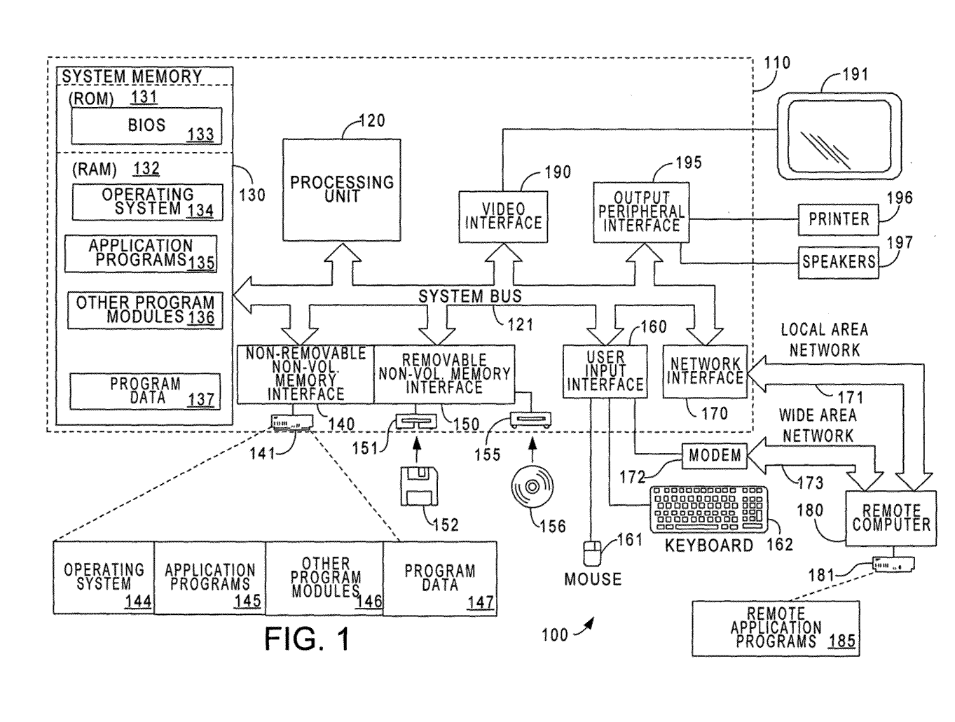

FIG. 1 illustrates an example of a suitable computing system environment 100 that may be used according to one or more illustrative embodiments of the invention. The computing system environment 100 is only one example of a suitable computing environment and is not intended to suggest any limitation as to the scope of use or functionality of the invention. The computing system environment 100 should not be interpreted as having any dependency or requirement relating to any one or combination of components illustrated in the computing system environment 100.

The invention is operational with numerous other general purpose or special purpose computing system environments or configurations. Examples of well known computing systems, environments, and/or configurations that may be suitable for use with the invention include, but are not limited to, personal computers, hand-held or laptop devices, tablet devices, phone devices, programmable consumer electronics, distributed computing environments that include any of the above systems or devices, and the like.

In one embodiment, a system is provided where employees in an organization are assigned a unique user id which is used to log into an interactive company-wide scoring portal. A back end gamification engine includes a continuous feed of employee performance data which is used to rank and assess the employees. The system in general facilitates a competition wherein employees are competing against fellow employees. The goal of each user is to earn points. In this embodiment, the person who scores the most points during a predetermined amount of time (such as a month) is determined as the winner. It can be appreciated that this system provides motivation for employees by creating a fun and interactive game for employees to compete in and enhance their overall productivity.

The system may include an input module that is utilized to input assessment data related to performance metrics for an employee, utilizing the assessment data from a plurality of evaluators. The system may further include a scoring component that creates a score of the currently assessed employee through a normalized method. The system may also include a display component that allows viewing of an employee's evaluation.

In one particular embodiment users score points by obtaining sales goals. The unique scoring mechanism comprises a normalized method wherein a user earns one point for every one percent of goal attainment across a plurality of scoring categories. For example, categories can be sales and margin data. In a particular embodiment, the categories are defined as sales in the following areas: Commercial, Residential, Parts, and Supplies. Users may also earn points across sales targets and margin targets. It can be appreciated that a variety of customizable categories may be provided to suit a particular type of business environment.

The scoring mechanism enables an even playing field for employees by basing the score on percentage increases. Thus, a new employee who may not have a huge amount of sales is not at a disadvantage against a more experienced employee who has already developed a large sales base. This scoring mechanism creates a level playing field by normalizing the scoring system.

The system may be set up such that a user is set up as a territory manager who is competing against other territory managers. The system may also contain a “commissioner” who is in charge of implementing the rules. In one embodiment, the commission is a supervisor in the organization.

The system can include communications forums such as a “chatter forum,” which allows various users to post competitive language, bluster, and other sorts of information. The system includes features such a posting, where posting can include filters based on the user. The system can also include a news page where sales manager can post interesting facts, sales, or to brag about individual performance.

The system may also include a performance scoreboard which provides information relating to (1) the ranking of each employee amongst others; (2) how each employee is performing in a plurality of performance metrics in relation to minimum standards, other employees, and/or the top performing employees; (3) what employees are in the top and what employees in the bottom as to each performance metric as well as overall; and/or (4) the level variance in performance amongst the employees. With this information, the organization may establish requisite levels of performance and take appropriate action to improve performance by underperforming employees.

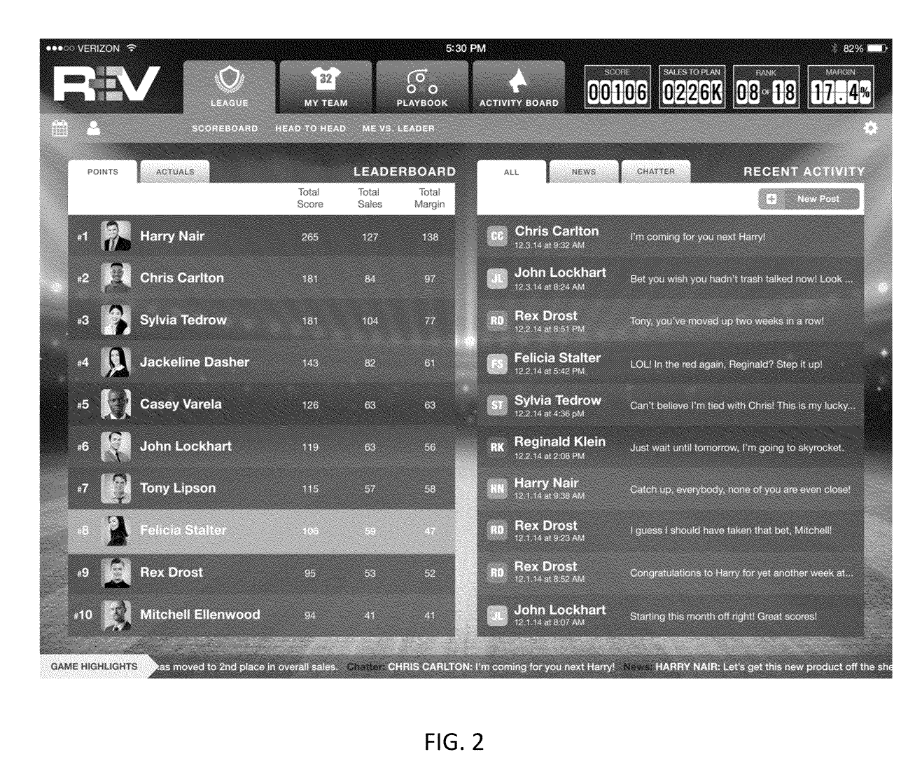

FIG. 2 is a “League Scoreboard” screenshot according to an embodiment of the present invention. The top right corner of the screen display a user's current month score, sales, rank and margin percentage. It can be appreciated that this screen allows a user to find where they and their opponents rank in the game. They will see how they and their opponents' points are comprised. Further, they can read posts from other users, including the management team. They can post to the activity board under the chatter section. The screen also allows a user to navigate to “Head-to-Head” or “Me vs. Leader” screens, as well as navigate to “My Team”, “Playbook”, or “Activity Board” screens. The bottom of the screen can show a ticker which displays game highlights such as whether any user has moved in the rankings, or messages which users have broadcast.

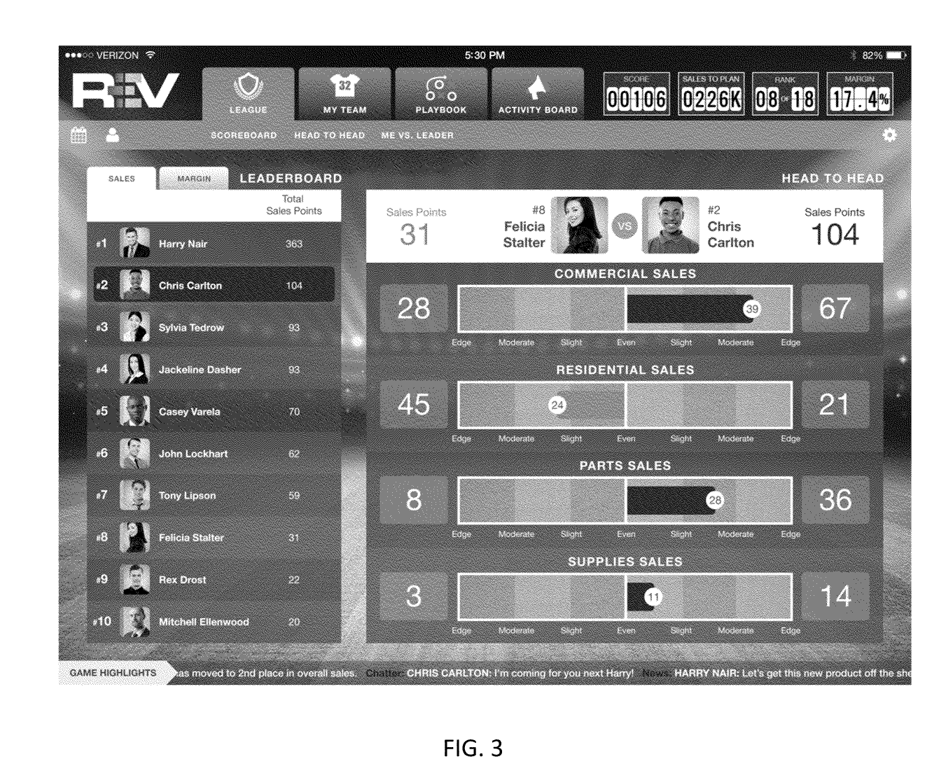

FIG. 3 is a “Head to Head” screen according to an embodiment of the present invention. It can be appreciated that this screen allows a user to see how they compare against other particular users. A user can also see how they are performing across different categories against a peer, see where they rank in the game, and see the product categories details other users are selling. This screen is useful to help a user learn from others and how they can improve their sales. Users can also navigate to the “Me vs Leader” screen by clicking “Me vs Leader” tab where a user can quickly find which user is the leader in each particular category. A user can also find out how many points they need to catch up to the leader. A user is able to filter leaders based on points or based on specific categories such as sales and margin dollars. A user is also able to display what the leader in each category is selling, and at what quantity, sales dollars, margin dollars, and margin percentage they are selling at. It can be appreciated that this screen allows an employee to learn from the leader by seeing what is enabling them to have such a high score.

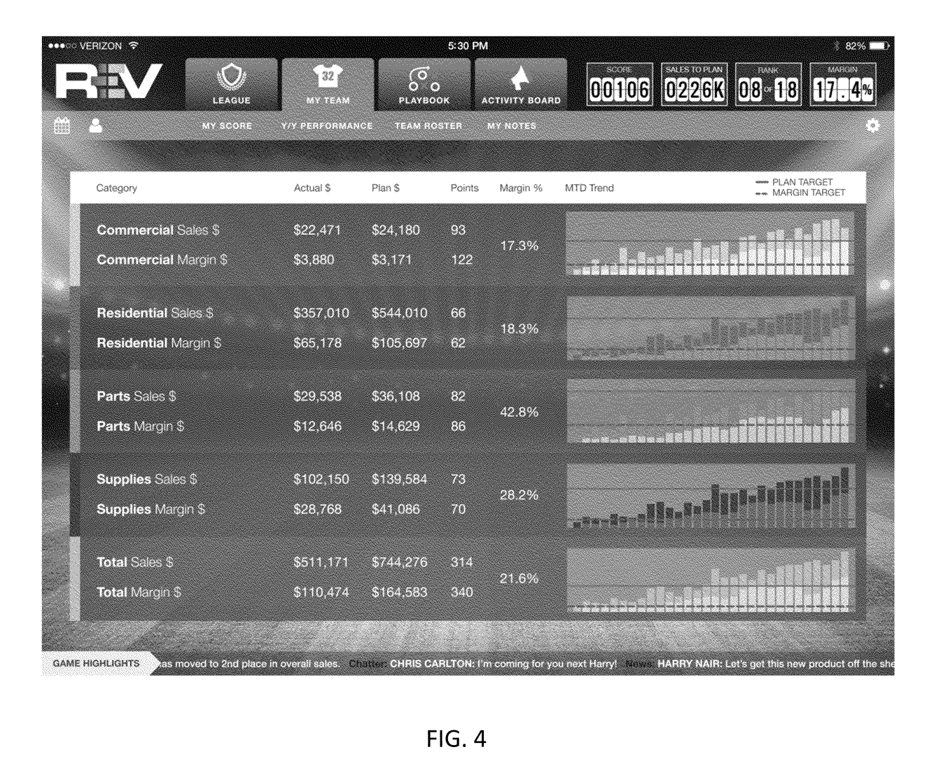

FIG. 4 is a “My Score” screen according to an embodiment of the present invention. This screen allows a user to understand the breakdown of their performance. The system outlines a high level of what the user is selling across each category. Further, a user can see the daily progression of their sales in a trend graph.

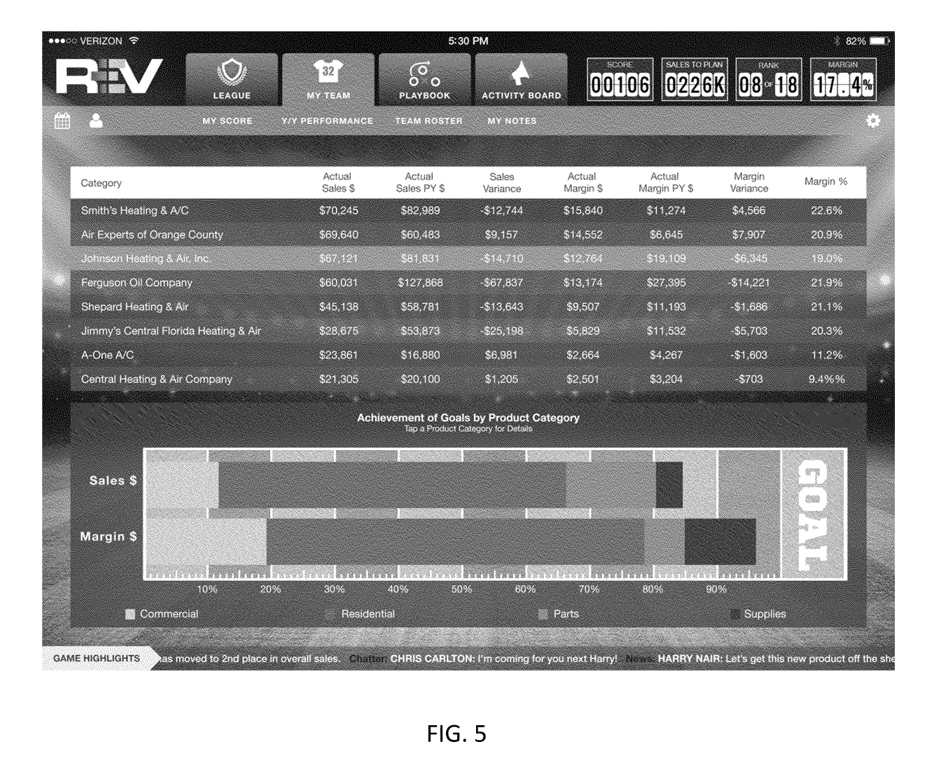

FIG. 5 is a “Team Roster” screen according to an embodiment of the present invention. It can be appreciated that this screen allows a user to see a breakdown of their sales performance across each of their customers. Additionally, the system displays a graph of how the user is performing towards their goal to each customer. The metrics may include Actual Sales, Plan Sales, Sales Variance, Actual Margin, Plan Margin, Variance, and Margin % all at the customer level. The system also includes a product category detail of the products the user has sold to each customer by category (Commercial, Residential, Parts or Supplies).

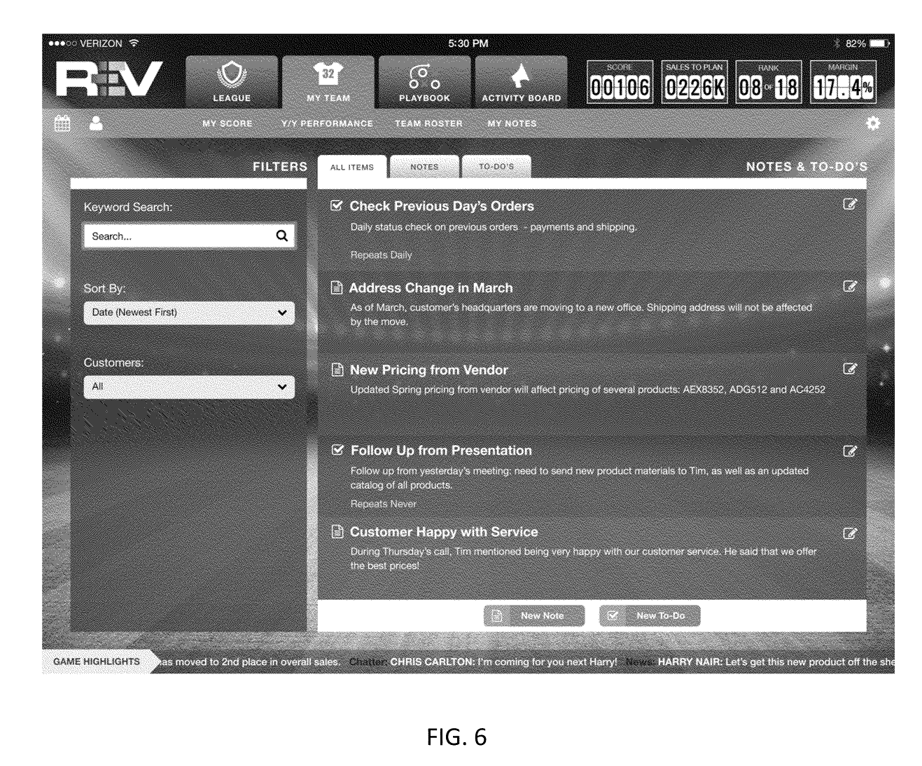

FIG. 6 is a “My Notes” screen according to an embodiment of the present invention. Here, users can add notes as well as “to-dos” by clicking on the appropriate icon on the bottom of the screen. Users can also search the notes and to-dos in the search bar, as well as sort by date and customer.

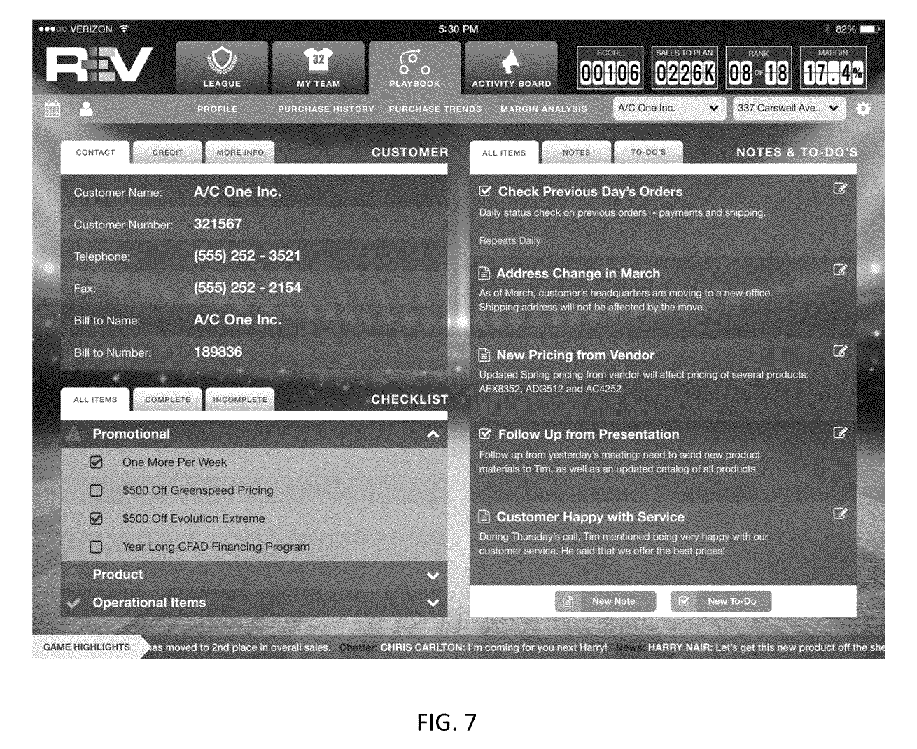

FIG. 7 is a “Playbook Profile” screen according to an embodiment of the present invention. This screen allows a user to see a quick CRM-like page of customer information for all of their customers. Key information includes Phonebook, Contact List, Customer Profile, Credit Profile, Financial Profile, and Order Fulfillment. Users can also click on the “Playbook Purchase Trends” screen according to an embodiment of the present invention, where a user can select a customer and see their year over year sales for that particular customer. Further, a user can look across all the different categories of sales, and can filter between sales dollars, margin dollars, and margin percentage.

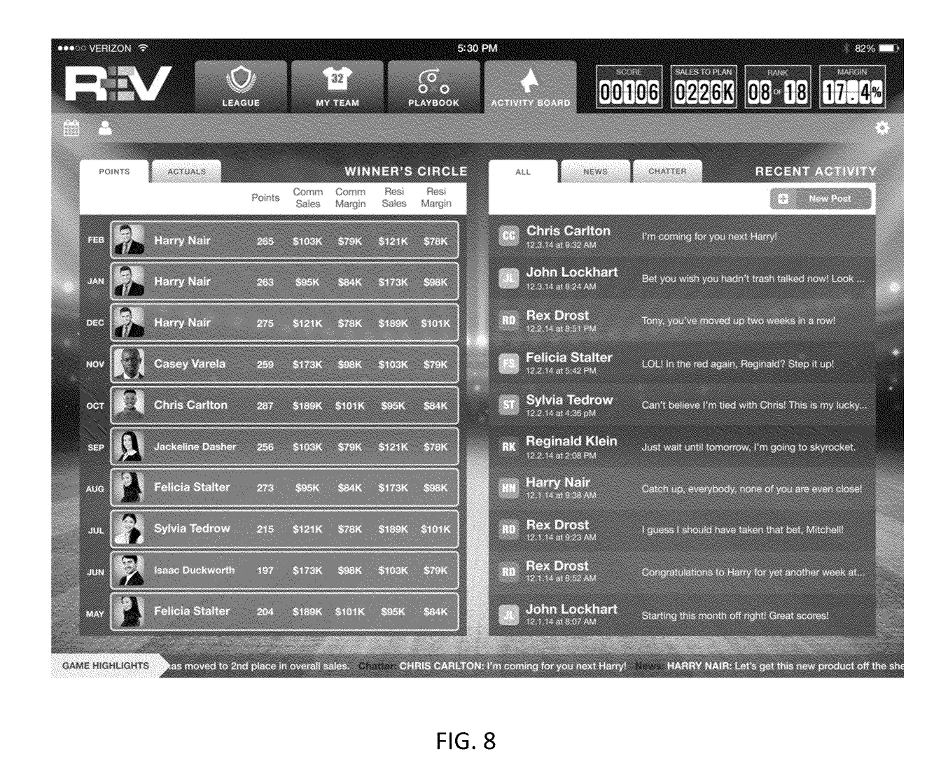

FIG. 8 is an “Activity Board” screen according to an embodiment of the present invention. This screen allows a user to see “Winner's Circle” displaying the winners of the system in the past, and their details across sales categories and margins. This screen also allows for the socialization aspect found on Scoreboard. Supporting details allows the user to understand what made a winner win that month's competition.

The exemplary systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, AWK, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like.

The systems and methods of the present disclosure may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

Although some of the screens illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuijten to fall outside the scope of patentable subject matter under 35 U.S.C. §101.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

1. A system for determining and ranking employee performance, comprising:
an input module that is utilized to input assessment data related to performance metrics for a currently assessed employee, wherein the assessment data comprises a plurality of evaluators including sales data;
a scoring component that determines a score of the currently assessed employee through a normalized method based on the assessment data; and
a display component that allows viewing of a performance scoreboard which provides information relating to the ranking of each employee amongst others, wherein the ranking of each employee is based on the score of each employee.

2. The system of claim 1, wherein the normalized method further comprises earning one point for every one percent of goal attainment across the plurality of evaluators.

3. The system of claim 2, wherein the plurality of evaluators includes scoring the employee's performance in sales of: commercial, residential, parts, and supplies.

4. The system of claim 3, further comprising:
an interactive message board configured to allow employees to post messages.

5. The system of claim 4, wherein the performance scoreboard also provides information as to how each employee is performing in relation to minimum standards.

6. The system of claim 5, wherein the display component display's the currently assessed employee's current month score, sales, rank and margin percentage.

7. The system of claim 6, wherein the display component allows viewing of the currently assessed employee in comparison to another selected employee.

8. A method for determining and ranking employee performance, comprising:
inputting assessment data related to performance metrics for a currently assessed employee, wherein the assessment data comprises a plurality of evaluators including sales data;
scoring the currently assessed employee through a normalized method; and
displaying a performance scoreboard which provides information relating to the ranking of each employee amongst others, wherein the ranking of each employee is based on the score of each employee.

9. The method of claim 8, wherein the normalized method further comprises earning one point for every one percent of goal attainment across the plurality of evaluators.

10. The method of claim 9, wherein the plurality of evaluators includes scoring the employee's performance in sales of: commercial, residential, parts, and supplies.

11. The method of claim 10, further comprising:
displaying an interactive message board configured to allow employees to post messages.

12. The method of claim 11, wherein the performance scoreboard also provides information as to how each employee is performing in relation to minimum standards.

13. The method of claim 12, wherein the displaying includes generating a page including the currently assessed employee's current month score, sales, rank and margin percentage.

14. The system of claim 6, wherein the displaying includes generating a page including a comparison of the currently assessed employee against another selected employee.

15. A non-transitory computer-readable storage medium having embodied thereon a program, the program being executable by a processor to perform a method for determining and ranking employee performance, comprising:
inputting assessment data related to performance metrics for a currently assessed employee utilizing assessment data from a plurality of evaluators, wherein performance metrics include sales data;
scoring the currently assessed employee through a normalized method; and
displaying a performance scoreboard which provides information relating to the ranking of each employee amongst others, wherein the ranking of each employee is based on the score of each employee.

16. The non-transitory computer-readable storage medium of claim 15, wherein the normalized method further comprises earning one point for every one percent of goal attainment across the plurality of evaluators.

17. The non-transitory computer-readable storage medium of claim 16, wherein the plurality of evaluators includes scoring the employee's performance in sales of: commercial, residential, parts, and supplies.

18. The non-transitory computer-readable storage medium of claim 16, the processor being further executable to display an interactive message board configured to allow employees to post messages/

19. The non-transitory computer-readable storage medium of claim 18, wherein the performance scoreboard also provides information as to how each employee is performing in relation to minimum standards.

20. The non-transitory computer-readable storage medium of claim 19, wherein the displaying includes generating a page including the currently assessed employee's current month score, sales, rank and margin percentage.
